(19) United States
(12) Patent Application Publication
(10) Pub. No.: US 2011/0167881 A1
(43) Pub. Date: Jul. 14, 2011

(54) ANTI-THEFT DEVICES FOR PORTABLE OBJECTS SUCH AS LAPTOPS

(76) Inventor: Meir Avganim, M.P. Nachal Sorek, (IL)

(21) Appl. No.: 13/119,687

(22) PCT Filed: Oct. 1, 2009
(86) PCT No.: PCT/IL2009/000942

§ 371 Date: Mar. 17, 2011

(30) Foreign Application Priority Data
Oct. 6, 2008 (IL) 194562

(51) Int. Cl. E05B 73/00

(52) U.S. Cl. 70/58

(57) ABSTRACT

An anti-theft arrangement for securing a portable object such as a laptop computer to an immovable object (27) by a cable (26) fastened at one end thereof to a key-operated locking device (20) adapted to become selectively locked against, and unlocked from, a side-wall (12) of the portable object. The arrangement comprises a polygonal opening (14) formed in the side-wall (12), a lock-body having a flat wall (28) formed with a fixed polygonal protrusion (30) configured to snugly fit into and through the opening (14). The locking device is accommodated within the lock-body (20) and comprises a rotor rotatable by a key over a pre-set angle equal to or less than 60°, and a polygonal element (32) of a size and shape identical to the polygonal protrusion (30) coupled to the rotor to rotate between an overlapping position and a non-overlapping position with respect to the protrusion (30).

### FIELD OF THE INVENTION

The present invention generally relates to security devices, and specifically to lockable devices of the type comprising a lock-body arrestable against a dedicated slot formed in a side-wall of the protected object, such as a portable computer, and a cable connect at one end to the lock-body whereas the other end is adapted to be tied to an immovable object such as a table leg.

### BACKGROUND OF THE INVENTION

Locks of the type above referred to are widely used. The most popular models are known in commerce as “KENSINGTON” locks (see for example U.S. Pat. Nos. 7,100,403, 7,111,479 and many others.)

These locks suffer, however, the following inherent deficiency: Since the operation is based on a T-shaped tip, which is adapted to be inserted into an elongated slot formed (by the manufacturers) in a side-wall of the portable computer and then turned by 90° to prevent the extraction thereof, an auxiliary, immobilizing mechanism must be installed to prevent the rotation of the lock-body proper when the tip is in the inserted, locking position. This mechanism is necessarily quite complicated, which accordingly reflects on the manufacturing costs as well as their durability.

It is therefore the prime object of the invention to overcome this drawback of the conventional locking devices.

It is a further object of the invention to altogether dispense with the auxiliary mechanism.

It is a still further object of the invention to change the shape of the tip from elongated to polygonal.

### SUMMARY OF THE INVENTION

Provided according to the invention is an anti-theft arrangement for securing a portable object to an immovable object by a cable fastened at one end thereof to a key-operated locking device adapted to become selectively locked against, and unlocked from, a side-wall of said portable object, the arrangement comprising a polygonal slot formed in said side-wall; a lock-body having a flat wall formed with a fixed polygonal protrusion configured to snugly fit into said slot; the locking device being accommodated within said lock-body, the device comprising: a rotor rotatable by a key over a pre-set angle equal or less than 60 degrees; an identically shaped polygonal element, coupled to the rotor to rotate between an overlapping and a non-overlapping position relative to said protrusion; and means for securing one end of said cable to the lock-body.

In the preferred embodiment of the invention the polygon is a regular triangle.

### BRIEF DESCRIPTION OF THE DRAWINGS

These and additional constructional features and advantages of the invention will become more clearly understood in the light of the following description of several preferred embodiments thereof, given by way of example only, with reference to the attached drawings, wherein—

FIG. 1 is a general, prospective view of the anti-theft device according to a preferred-embodiment of the invention in its operative, secured position;

FIG. 2 is a view of the designated slot formed in a side-wall of a portable computer;

FIG. 3 is a front, perspective view of the locking device in a preparatory position; and

FIG. 4 depicts the locking position.

### DETAILED DESCRIPTION OF THE PREFERRED EMBODIMENT

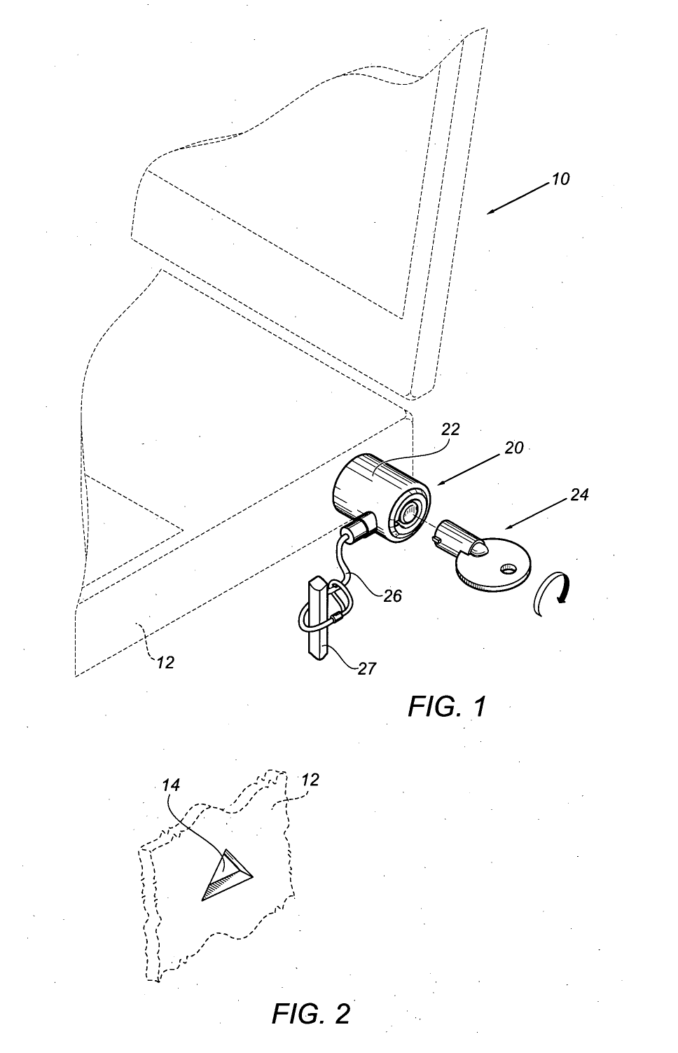

Shown in phantom lines in FIG. 1 in a typical portable (laptop) computer 10, a portion 12 of its side wall is shown in FIG. 2.

Unlike the traditional shape of the security slots common to all previously known locking arrangements, namely employing a T-shaped tip fitting an oblong rectangular slot, a regular triangular slot or opening 14 is used.

Obviously, the application of the present invention is not limited to a triangle (regular or non-regular), but also to other polygons (e.g. square), although being less effective as will become clear in the light of the following description.

The security device generally denoted 20 in of the conventional shaped, having a cylindrical body 22 and operated by key 24 of any suitable type, effective to turn a rotor (not shown) by a pre-set angle (60 degrees in the present example—see below) in the locking and unlocking directions.

The lock body 22 is connectable by a security cable 26 to an immovable object, such as around a table leg 27, all as conventionally known.

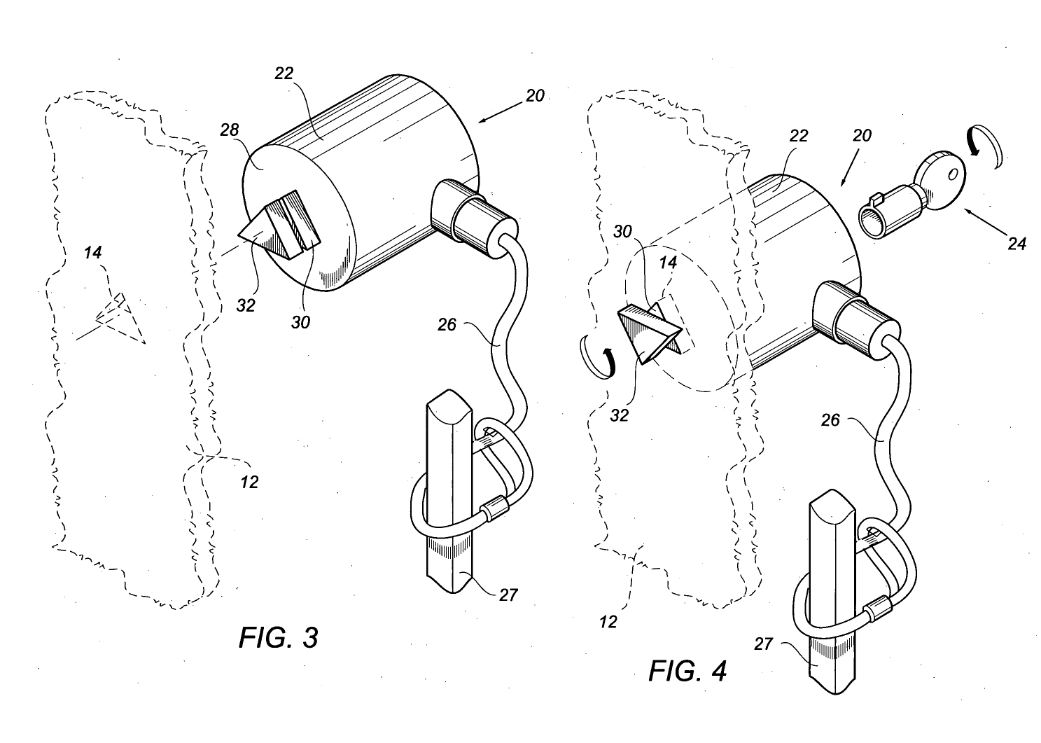

As clearly seen in FIG. 3, the lock body 22 has a front planar wall 28. A triangular protrusion 30 forms part of or is affixed to the wall 28, and being of a width slightly exceeding the width of the laptop side-wall 12. Overlapping the triangle 30 is a second triangular element 32.

The element 32 is rotatable by the rotor of the locking mechanism in one or the opposite directions, as seen in FIG. 4. Details of coupling the element 32 to the key-operated rotor (cylinder) need not be explained in detail as being obvious to anybody skilled in the locking devices field.

Harnessing the lock body 22 to the opening 14 of the laptop wall 12 is effected by inserting both triangles 30 and 32 therethrough, and than turning the key 24 by about 60°, away from the previous overlapping state.

No additional security means are required, since rotation of the lock-body proper, in an attempt to negate the locking position, is prevented by the protrusion 30 snugly fitting the opening 14.

Unlocking can only be perfected by bringing the element 32 back to the superimposed position relative to the protrusion 30 (as in FIG. 3), namely by operating the key 24 (by the authorized holder).

It goes without saying that in order to apply the invention, computer manufactures will have to cooperate by changing the shape of the conventional, elongated slot into triangular (or other polygonal shapes).

It will be thus clearly seen that locking devices designed according to the principles of the present invention are of a most simple construction, involving a minimum number of moving parts and hence less costly in production and of a more reliable operation.

Those skilled in the art to which this invention pertains will readily appreciate that numerous changes, variations and modifications can be effectuated without departing from the true spirit and scope of the invention as defined in and by the appendent claims.

What is claimed is:

1. An anti-theft arrangement for securing a portable object to an immovable object by a cable fastened at one end thereof to a key-operated locking device adapted to become selectively locked against, and unlocked from, a side-wall of said portable object, the arrangement comprising:
A. A polygonal opening formed in said side-wall;
B. A lock-body having a flat wall formed with a fixed polygonal protrusion configured to snugly fit into and through said opening;
C. The locking device being accommodated within said lock-body, the device comprising:
a rotor rotatable by a key over a pre-set angle equal to or less than 60°;
A polygonal element of a size and shape identical to the polygonal protrusion, coupled to the rotor to rotate between an overlapping position and a non-overlapping position with respect to said protrusion.

2. The arrangement as claimed in claim 1 wherein the said polygonal protrusion is a regular triangle.

3. The arrangement as claimed in claim 2 wherein the height of the polygonal protrusion slightly exceeds the width of the said side-wall.

4. The arrangement as claimed in any of the preceding claims wherein the portable object is a laptop computer.
